(19) United States
(12) Patent Application Publication
(10) Pub. No.: US 2012/0250457 A1
(43) Pub. Date: Oct. 4, 2012

(54) SYSTEMS AND METHODS FOR WIRELESS COMMUNICATION IN A GEOPHYSICAL SURVEY STREAMER

(75) Inventors: William Thomas RICKERT, JR., Sugar Land, TX (US); Stig Rune Lennart Tenghamn, Katy, TX (US)

(73) Assignee: PGS Americas, Inc., Houston, TX (US)

(21) Appl. No.: 13/073,832

(22) Filed: Mar. 28, 2011

(51) Int. Cl. G01V 1/38

(52) U.S. Cl. 367/20

(57) ABSTRACT

A disclosed survey method includes towing geophysical survey streamers in a body of water and using sensors within the streamer to collect measurements that are then conveyed along the streamer to a recording station using at least one wireless transmission link. In some implementations at least one sensor is coupled to a wireless transceiver in a streamer to transmit geophysical survey measurement data along the streamer to a wireless base station. The base station receives the wirelessly transmitted seismic data and communicates it to a central recording station. Each segment of the streamer may contain a base station to collect wireless data from the sensors in that segment, and each base station may be coupled to the central recording station by wiring (e.g., copper or fiber optic). Other implementations employ ranges of sensors wired to local transceivers that form a peer-to-peer wireless network for communicating data to the central recording station.

### CROSS-REFERENCE TO RELATED APPLICATIONS

The present application relates to co-pending U.S. application Ser. No. ______ (Atty Dkt PGS-10-36), titled “Systems and Methods for Energy Harvesting in a Geophysical Survey Streamer” and filed by inventor S. Rune Tenghamn on the same day as the present application.

### BACKGROUND

Scientists and engineers often employ geophysical surveys for exploration, archeological studies, and engineering projects. Geophysical surveys can provide information about underground structures, including formation boundaries, rock types, and the presence or absence of fluid reservoirs. Such information greatly aids searches for water, geothermal reservoirs, and mineral deposits such as hydrocarbons and ores. Oil companies in particular often invest in extensive seismic and electromagnetic surveys to select sites for exploratory oil wells.

Seismic and electromagnetic surveys can be performed on land or in water. Marine surveys usually employ sensors below the water's surface, e.g., in the form of long cables or “streamers” towed behind a ship, or cables resting on the ocean floor. A typical streamer includes sensors positioned at spaced intervals along its length. Several streamers are often positioned in parallel over a survey region.

For seismic surveys, an underwater seismic wave source, such as an air gun, produces pressure waves that travel through the water and into the underlying earth. When such waves encounter changes in acoustic impedance (e.g., at boundaries between strata), some of the wave energy is reflected. The seismic sensors in the streamer(s) detect the seismic reflections and produce output signals. The sensor output signals are recorded, and later interpreted to infer structure of, fluid content of, and/or composition of rock formations in the earth's subsurface.

Similarly, for electromagnetic surveys, a underwater electrodes generate current flows in the water and the subsurface formations. Such current flows cause voltage drops to build and decay across subsurface formations and interfaces, thereby producing electric fields that can be sensed by antennas or electrodes in an underwater streamer. The sensor output signals are recorded, and later interpreted to infer structure of, fluid content of, and/or composition of rock formations in the earth's subsurface.

Conventional marine geophysical survey streamers may include hundreds, or even thousands, of sensors that are concurrently recording and communicating high resolution digital data to the ship and drawing power from the ship as they operate. The wiring that is typically employed to provide power and support communication may become a limiting factor as attempts are made to provide ever-longer streamers with improved performance. Though the use of more wiring can be offset by increasing the diameter of the streamer cable (so as to maintain a neutral buoyancy), the increased diameter tends to cause increased drag, to cause streamers to occupy substantially more room on the ship, and to make handling more difficult.

### BRIEF DESCRIPTION OF THE DRAWINGS

A better understanding of the various disclosed system and method embodiments can be obtained when the following detailed description is considered in conjunction with the drawings, in which:

FIG. 1 is a side elevation view of an illustrative marine geophysical survey system;

FIG. 2 is a top plan view of the marine geophysical survey system of FIG. 1;

FIG. 3a is a schematic of multiple streamer segments in an illustrative streamer cable;

FIG. 3b is a detailed view of an illustrative streamer segment;

FIG. 3c shows wireless communication between a router and sensor;

FIG. 4a is another detailed view of an illustrative streamer segment;

FIG. 4b shows an illustrative view of a data acquisition huh;

FIG. 5 shows an illustrative, wireless sensor device; and

FIG. 6 is a flow diagram of an illustrative geophysical survey method.

### DETAILED DESCRIPTION

The issues identified in the background are at least in part addressed by the disclosed systems and methods for providing wireless communication in a geophysical survey streamer. At least some embodiments of a disclosed survey method include towing geophysical survey streamers in a body of water and using sensors within the streamer to collect measurements that are then conveyed along the streamer to a recording station using at least one wireless transmission link. In some implementations at least one sensor is coupled to a wireless transceiver in a streamer to transmit geophysical signal measurement data along the streamer to a wireless base station. The base station receives the wirelessly transmitted measurement data and communicates it to a central recording station. Each segment of the streamer may contain a base station to collect wireless data from the sensors in that segment, and each base station may be coupled to the central recording station by wiring (e.g., copper or fiber optic). Other implementations employ ranges of sensors wired to local transceivers that form a peer-to-peer wireless network for communicating data to the central recording station.

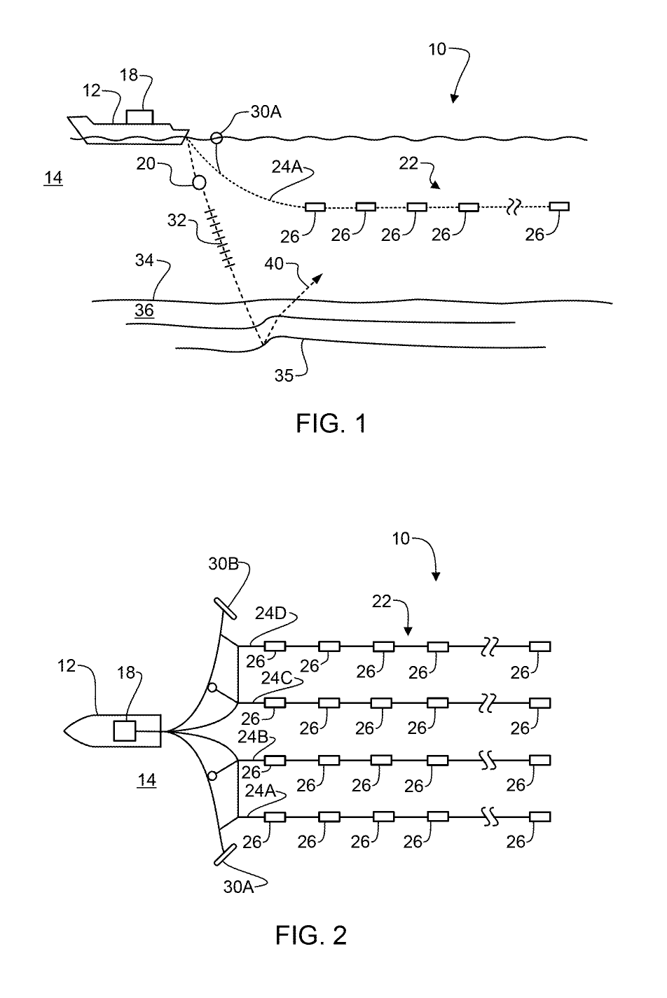

To assist the reader's understanding of the disclosed systems and methods, we first describe the context for their use and operation. Accordingly, FIGS. 1 and 2 respectively show a side and top view of an illustrative marine geophysical survey system 10 performing a marine seismic survey. A survey vessel or ship 12 moves along the surface of a body of water 14, such as a lake or an ocean. The ship 12 tows an array of streamers 24A-24D, each streamer having multiple segments (aka sections) 26 connected end to end. Within each segment 26 are evenly spaced seismic sensor units that detect and digitize seismic energy measurements and provide those measurements to a data recording and control system 18 aboard the ship 12. Survey system 10 further includes at least one seismic source 20, which may also be towed through the water 14 by the ship 12.

The streamers 24A-24D are towed via a harness that produces a desired arrangement of the streamers 24A-24D. The harness includes multiple interconnected cables, and a pair of controllable paravanes 30A and 30B connected to opposite sides of the harness. As the ship 12 tows the harness through the water 14, the paravanes 30A and 30B pull the sides of the harness in opposite directions, transverse to a direction of travel of the ship 12. Depth-controllers may also be provided along the length of the streamer to keep the streamer array largely horizontal.

The seismic source 20 produces acoustic waves 32 under the control of the data recording and control system 18, e.g., at regular intervals or at selected locations. The seismic source 20 may be or include, for example, an air gun, a vibratory source, or another form of seismic energy generator. The acoustic waves 32 travel through the water 14 and into a subsurface 36 below a bottom surface 34. When the acoustic waves 32 encounter changes in acoustic impedance (e.g., at boundaries between strata), some of the wave energy is reflected. In FIG. 1, ray 40 represents wave energy reflected in a particular direction from interface 35.

Sensor units of the sensor array 22, housed in the streamer sections 26 of the streamers 24A-24D, detect these seismic reflections and produce output signals. The output signals produced by the sensor units are recorded by the data recording and control system 18 aboard the ship 12. The recorded signals are later interpreted to infer structure of, fluid content of and/or composition of rock formations in the subsurface 36.

There are often thousands of detectors in a given sensor array 22. A modular construction, e.g., with substantially identical and interchangeable sections 26, greatly simplifies handling, maintenance, and repair. If a problem develops with one of the streamer sections 26, the problematic streamer section 26 can be replaced by any other spare streamer section 26. The wiring that is typically employed to provide power and support communication may become a limiting factor as attempts are made to provide ever-longer streamers with improved performance. Accordingly, streamers 24 may be modified to employ wireless communications so as to reduce wiring requirements.

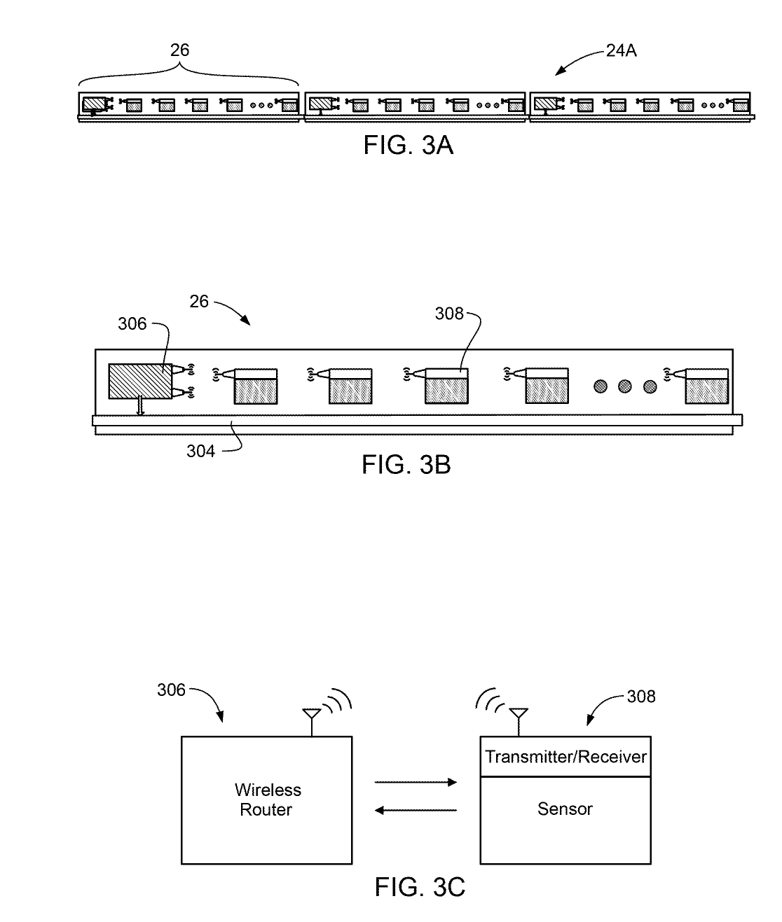

FIGS. 3A and 3B illustrate an embodiment of a seismic streamer cable 24A with multiple streamer segments 26 connected in series. Sensor units 308 are located inside the seismic streamers to detect and digitize measurements of seismic waves that are reflected back from sub-sea structures. FIG. 3B shows that illustrative segment 26 includes multiple, spaced-apart sensor units 308, at least one wireless base station 306, and a data transport backbone 304. The data transport backbone 304 transports data along the streamer segments 26 to the ship 12, and may further communicate commands and configuration parameters from the ship to the base stations 306 and thence to the sensor units. The data transport backbone may include one or more fiber optic cables or conductors that serve as a communications pathway for optical or electrical signals, and may further include amplifiers or repeaters to extend the transmission range of those signals. Connectors between the segments couple the backbones together to permit communication along the entire length of the streamer. A gel or foam material may be included within the streamer to support the components and provide the segment with a neutral buoyancy. Other potential filler materials include nonconductive fluids, plastics, and aerogels. For the reasons described further below, one of the considerations in selecting or designing the internal filler material is a low attenuation factor for high-frequency electromagnetic signals.

The wireless base stations 306 are coupled to the data transport backbone to communicate data to the recording and control system 18 and optionally to receive commands and configuration information from the recording and control system. As illustrated in FIG. 3C, the wireless base stations 306 communicate wirelessly with the sensor units 308 to obtain the seismic data and optionally to provide configuration information. Among other things, the wireless base stations 306 may transmit a beacon signal that can be used by the sensor units to synchronize their internal clocks.

The sensor units 308 operate to acquire the seismic signal data, to buffer it as needed, and to communicate the acquired signal data to the base station 306. In some embodiments the sensor units can accept commands to adjust their operating parameters, including internal clock timing, sampling frequency, bit resolution of the samples, compression quality, communication format, and so on. To acquire the data, the sensor units may include hydrophones, geophones, accelerometers, gyroscopes, inertial sensors, strain sensors, magnetic field sensors, or other types of transducers that suitable for detecting seismic waves.

It is contemplated that in at least some embodiments, the sensor units may be individual digital transducers. Examples of suitable digital transducers include those described by C. P. Lewis. “Simulation of a micromachined digital accelerometer . . . ”, UKACC International Conference on Control '96 (Conf. Publ. No. 427), v1, p 205-209, September 1996. The sigma-delta output of such transducers can be used to directly modulate a radio frequency carrier signal, or used to determine a register value that is periodically read by the wireless transceiver and transmitted to a base station.

Power can be supplied to the sensor units in a number of ways. In some embodiments, the sensor units are connected to the backbone to receive power. In other embodiments, the sensor units are inductively or capacitively coupled to the backbone to receive power without being directly wired to the backbone. In yet other embodiments, the sensor units are battery powered. Some embodiments include energy harvesters that convert motion or vibration into electrical power. Many of these embodiments enable the sensor units to be modular units that can be easily replaced without requiring significant rewiring effort and/or re-sealing of the segment casing.

The streamer segments can employ any one of a number of wireless communication protocols to communicate data from the sensors to the base stations. For instance, some embodiments would employ the 2.4 GHz Zigbee standard, which incorporates the Institute of Electrical and Electronics Engineers (IEEE) standard 802.15.4 physical radio specification (ratified in 2003). The specification is a packet-based radio protocol designed for low-cost, low-power devices. The protocol allows devices to communicate in a variety of network topologies and can have battery life lasting several years. The basic framework conceives a 10-meter communications range with a transfer rate of 250 kbit/s.

Other embodiments may employ the Rubee (IEEE 1902.1) communications protocol. Rubee is a bidirectional, peer-to-peer standard, designed to perform in harsh environments. Rubee employs the near-field component of a low frequency carrier (131 kHz) for communication, and it is expected to be suitable for use in low-power devices. Because RuBee uses long wavelengths and works in the near field (under 50 feet) it is possible to simultaneously transmit and receive from many adjacent antennas without interference, providing the signals are synchronized.

Still other embodiments may employ the Bluetooth standard or one of the IEEE 802.11 (“WiFi”) standards, both of which are commonly employed for wireless computer networks. These standards all provide for communication carrier frequencies above 2.4 GHz, making their wavelengths less than 10 cm or so. Whichever communications standard is chosen, the wireless signal is expected to be contained within and channeled by the segment. The water is expected to be conductive enough to contain the radiated signal within the streamer, but if desired the streamer can be designed with a high refractive index and/or a conductive sheath to further enhance containment of the wireless signals.

Because the wireless signals propagate inside the streamer, they do not suffer the high degree of attenuation that would otherwise be expected for wireless signals transmitted underwater, particularly in a salt water environment. The use of wireless signals to communicate data along the cable reduces wiring requirements, enabling a consequent reduction in weight and diameter, which in turn reduces the stiffness of the streamer and also enables longer streamers to be assembled.

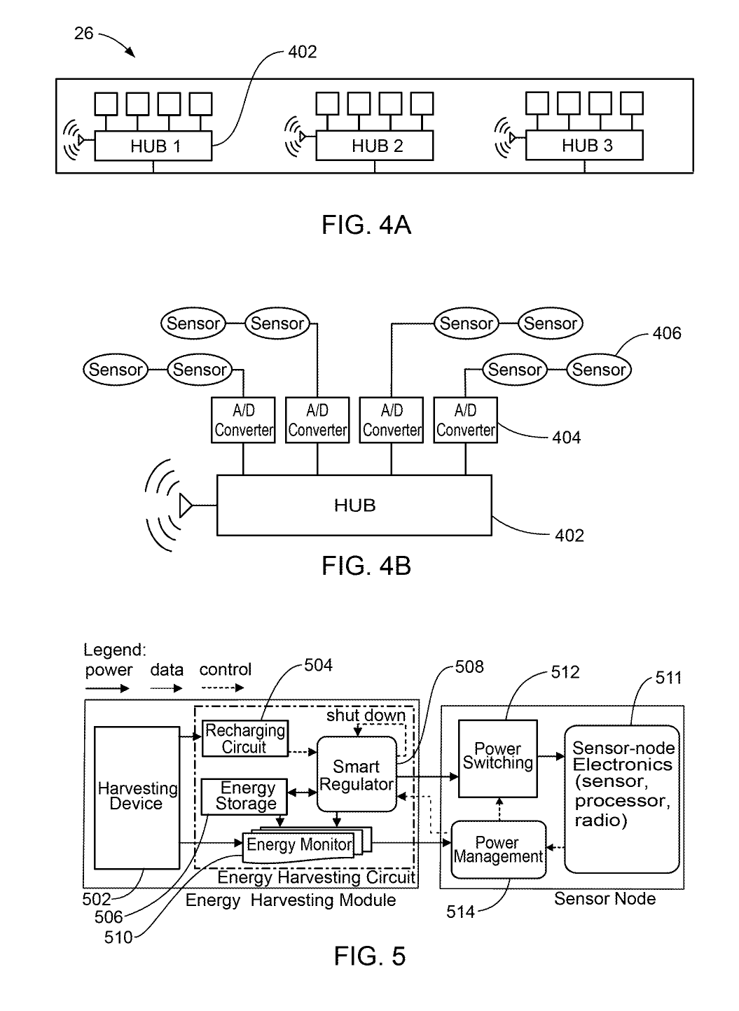

FIGS. 4A-4B illustrate an alternative embodiment of a streamer segment 26 having evenly spaced instrumentation hubs 402 which form a peer-to-peer wireless network to communicate data along the streamer to the ship 12. In addition to acquiring and buffering seismic data from local sensors for transmission, each hub is further configured to receive messages from other hubs and re-transmit them to enable data to pass along the streamer from one hub to the next to eventually reach the ship. Peer-to-peer wireless networks may advantageously enable the wireless communications range to be extended along the length of the streamer without requiring the placement of nearby wireless routers to provide each hub with direct access to a wired data backbone.

Each hub 402 supports a set of analog-to-digital converters 404 that convert analog measurement signals into digital form. A set of seismic sensors 406 is wired to each analog-to-digital converter 404. Depending on the design, each set of sensors 406 may be wired in parallel to provide a single analog signal to each converter 404. Alternatively, the sensor signals may be time multiplexed so that the converter 404 samples each signal in turn. As before, the sensors 406 may be hydrophones, single or multi-axis motion sensors (e.g., geophones, accelerometers, gyroscopes, inertial sensors), strain sensors, field sensors, or some combination thereof. When wired in parallel, the sensors are expected to provide improved signal-to-noise ratio at the expense of spatial resolution. Conversely, when the sensor signals are individually sampled, improved spatial resolution is obtained at the cost of some reduction in signal to noise ratio.

In an illustrative embodiment, one streamer segment includes 12 sensor groups, each sensor group extending for approximately 12 meters and including between 4 and 40 sensors. The maximum sampling rate is expected to be around 1 kHz, with each sample having up to 24 bit resolution. With the use of wireless communication, less wiring is needed within the streamer casing. It is contemplated that the cable diameter can be reduced from 64 mm to 48 mm.

To further reduce wiring requirements, the wireless sensor units 308 or the hubs 402 may be powered by an energy harvesting device. FIG. 5 shows an illustrative wireless sensor unit powered by an energy harvesting module. The module includes an energy harvesting device 502 that converts vibratory motion into electrical energy. Circuitry coupled to the harvesting device includes a recharging circuit 504 to convert alternating current from the harvesting device 502 into direct current, with suitable predefined limits on the output voltage and current. A smart regulator 508 stores excess energy in a storage device 506 such as a rechargeable battery or an ultra-capacitor. As power is required by the sensor node, the smart regulator draws on the harvesting device 502 and the storage device 506 as necessary to supply it. Where insufficient power is available, the smart regulator can automatically shut down the power output so as to accumulate energy in the energy storage device 506. An energy monitor 510 collects status measurements from the harvesting device 502, the energy storage device 506, and the smart regulator 508.

These status measurements are supplied to a power management circuit 514 in the sensor node which uses these measurements to determine the operating parameters of the sensor node electronics and thereby manage their power requirements. A power switching circuit 512 operates under control of the power management circuit 514 to deliver power to those portions of the sensor node electronics 511 that the power management circuit 514 selects based on the amount of stored energy and the rate at which additional energy is being harvested. With the built-in power management algorithm, the power management circuit 514 makes decision to either turn on or off the power switching 512 and control and optimize the functions of the smart regulator 508.

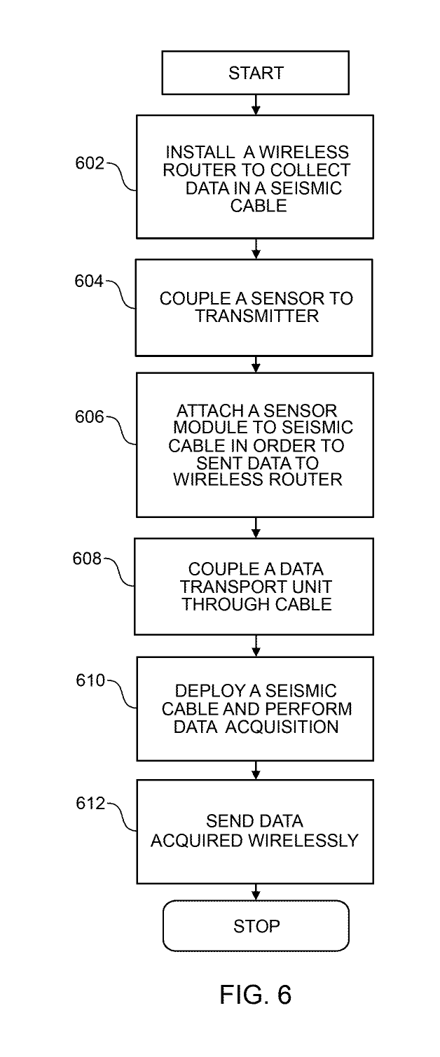

FIG. 6 shows an illustrative seismic survey method, which begins with the manufacture of streamer cable segments. In block 602, the manufacturer wires the base station (wireless router) to the data transport backbone, thereby enabling the base station to communicate along the backbone to other connected segments and to the ship. In block 604, the manufacturer assembles wireless sensor units by, inter alia, connecting a sensor package to a wireless transceiver. As previously discussed, the sensor unit may include an internal power supply (e.g., a battery and/or energy harvester), or may include coupling circuitry to receive wireless power from the backbone, or optionally a set of terminals to make direct electrical contact with power supply terminals on the backbone.

Once assembled, the wireless sensor units are installed in the cable segment in block 606. Some cable embodiments provide sockets into which the wireless sensor units can be inserted, thereby enabling straightforward maintenance and repair procedures. Other cable embodiments have the wireless sensor units integrated before the streamer casing is installed. Once the streamer segments have been completed, the segments are coupled end-to-end in block 608 to form a complete streamer which can be deployed in block 610 to collect seismic survey data. The sensor units detect and digitize data in response to seismic shots, and in block 612 they communicate that data wirelessly to the base stations, which in turn communicate the data along the backbone to the recording system on the ship.

While specific system and method embodiments have been described above, it should be understood that they are illustrative and not intended to limit the disclosure or the claims to the specific embodiments described and illustrated. Numerous variations and modifications will become apparent to those skilled in the art once the above disclosure is fully appreciated. For example, the streamers may be electromagnetic survey streamers rather than seismic survey streamers. The streamers can rest on the ocean floor (or indeed, on dry land) instead of being towed. Some segments of a given streamer may employ wireless communications while others do not. Other protocols can be employed besides those described herein. It is intended that the following claims be interpreted to embrace all such variations and modifications.

What is claimed is:

1. A geophysical survey streamer segment that comprises:
at least one group of geophysical survey sensors that operate underwater to provide one or more signals; and
a hub that converts the one or more signals into digital data, wherein the hub communicates wirelessly with other hubs to convey the digital data to a recording system.

2. The segment of claim 1, wherein the hub transmits a wireless signal that is substantially contained within the streamer segment as it propagates.

3. The segment of claim 1, wherein the hub conveys digital data using a near field wireless signal.

4. The segment of claim 1, wherein the hub employs wireless signal frequencies above 2 GHz to convey said digital data.

5. The segment of claim 1, wherein the hub establishes a peer-to-peer wireless network that includes hubs in other streamer segments.

6. The segment of claim 1, wherein the hub includes a battery as a power source.

7. The segment of claim 1, wherein the hub includes an energy harvester to convert vibrations into electrical power.

8. A marine geophysical survey streamer segment that comprises:
a data transport backbone that extends along the marine geophysical survey streamer segment;
at least one base station that communicates with a recording system via the data transport backbone; and
wireless stations that wirelessly transmit sample data from geophysical survey sensors to the at least one base station.

9. The segment of claim 8, wherein wireless transmissions from the wireless stations are channeled within the streamer segment.

10. The segment of claim 8, wherein the wireless stations communicate the sample data using a near field wireless signal.

11. The segment of claim 8, wherein the wireless stations employ wireless signal frequencies above 2 GHz to convey said sample data.

12. The segment of claim 8, wherein the wireless stations each include a battery as a power source.

13. A geophysical survey method that comprises:
towing at least one geophysical survey streamer in a body of water;
collecting measurements of induced geophysical survey signals using sensors in said streamer; and
conveying said measurements along the streamer to a recording station, wherein said conveying includes wirelessly transmitting at least some of the measurements from one point in the streamer to another point in the streamer.

14. The method of claim 13, wherein said wirelessly transmitting is performed between hubs that are each wired to local seismic sensor groups.

15. The method of claim 14, wherein said hubs form a peer-to-peer wireless network to convey said measurements along the streamer.

16. The method of claim 15, further comprising powering said hubs with chemical batteries.

17. The method of claim 13, wherein said wirelessly transmitting is performed between base stations wired to a data transport backbone and wireless stations spaced along the streamer.

18. The method of claim 13, wherein said wirelessly transmitting employs near-field wireless signals to convey said data.

19. The method of claim 13, wherein said wirelessly transmitting employs wireless signal frequencies above 2 GHz to convey said data.

20. The method of claim 13, wherein the induced geophysical survey signals comprise seismic wave reflections from subsurface formations.

21. The method of claim 13, wherein the induced geophysical survey signals comprise electromagnetic signals caused by induced current flows in subsurface formations.
